(19) United States
(12) Patent Application Publication
(10) Pub. No.: US 2011/0010842 A1
(43) Pub. Date: Jan. 20, 2011

(54) SEAT ADJUSTMENT DEVICE

(76) Inventor: Quy That Ton, Baton Rouge, LA (US)

Correspondence Address: DUANE MORRIS LLP - Atlanta;IP DEPARTMENT, ATLANTIC CENTER PLAZA, 1180 WEST PEACHTREE STREET, NW SUITE 700, ATLANTA, GA, 30309-3348, US

(21) Appl. No.: 12/838,971

(22) Filed: Jul. 19, 2010

Related U.S. Application Data
(60) Provisional application No. 61/226,699, filed on Jul. 18, 2009.

(51) Int. Cl. A61H 33/00; A47C 7/62; A47C 7/46; A47C 31/00; A61H 99/00

(52) U.S. Cl. 4/621; 297/188.01; 297/219.1; 601/1

(57) ABSTRACT

A representative seat adjustment device includes a body, at least two extensions that are connected to the body, and attachment elements that are placed at the tip of the at least two extensions. The attachment elements attach to each other securing the at least two extensions together. The seat adjustment device further includes a cover that covers the body and the at least two extensions.

### CROSS REFERENCE TO RELATED APPLICATIONS

This application claims the benefit of U.S. provisional application entitled, “A Seat Adjustment Device,” having Ser. No. 61/226,699, filed on Jul. 20, 2009, which is entirely incorporated herein by reference.

### TECHNICAL FIELD

The present disclosure is generally related to a seat adjustment device and, more particularly, is related to a spa apparatus having a seat adjustment device.

### BACKGROUND

The pedicure industry is expanding in today's economy. A pedicure spa is located in many pedicure salons and many salon professionals are now trained to administer a pedicure to their various clients. Clients sit at the pedicure spa where technicians can provide pedicure services as well as other spa services. Salon professionals or pedicurists render treatment and comfort of the feet of a person in addition to other included services.

### SUMMARY

A representative seat adjustment device includes a body, at least two extensions that are connected to the body, and attachment elements that are placed at the tip of the at least two extensions. The attachment elements attach to each other securing the at least two extensions together. The seat adjustment device further includes a cover that covers the body and the at least two extensions.

### BRIEF DESCRIPTION OF DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, the reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

FIG. 1 is a perspective view of a spa apparatus having a seat adjustment device according to one embodiment of the disclosure; and

FIGS. 2, 3, and 4 are front, side, and top views, respectively, of an embodiment of a spa apparatus having a seat adjustment device, such as that shown in FIG. 1.

### DETAILED DESCRIPTION

Exemplary systems are first discussed with reference to the figures. Although these systems are described in detail, they are provided for purposes of illustration only and various modifications are feasible.

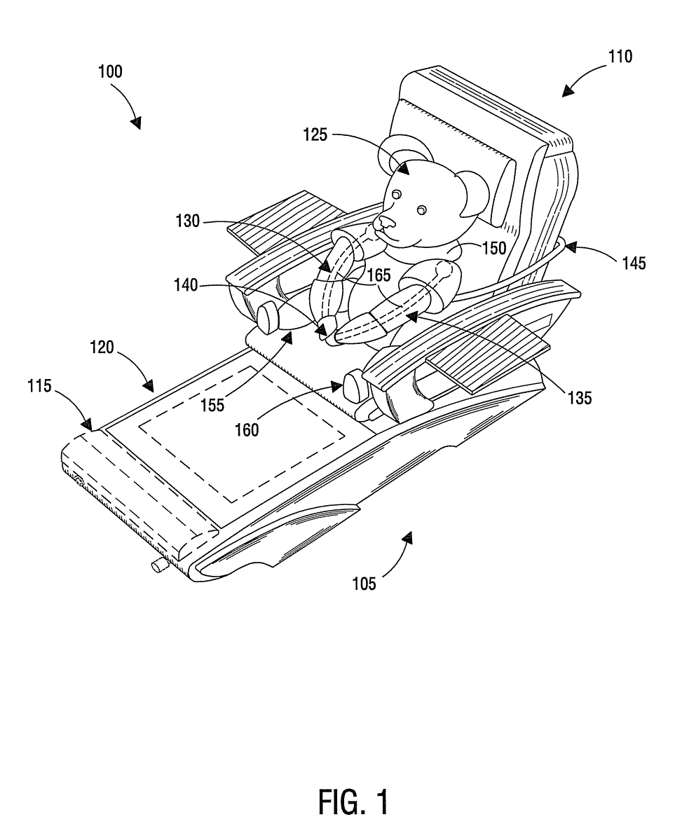

FIG. 1 is a perspective view of a spa apparatus 100 having a seat adjustment device 125 according to one embodiment of the disclosure. The spa apparatus 100 includes a base structure 105 in which the chair 110 and the basin 120 are mounted thereon. The base structure 105 can further include a footrest 115 in front of the base structure 105 such that the basin 120 is positioned between the footrest 115 and the chair 110. In general, the spa apparatus 100 is designed for adult customers having “normal” height, e.g., approximately 4.5′ to 7′ tall.

A seat adjustment device 125 can used with the spa apparatus 100 to accommodate customers who are below the “normal” height of an adult customer, such as kids who are shorter than approximately 4.5′ tall. The seat adjustment device 125 includes a cover 150 that can be designed to resemble a “Teddy” bear, but can be any shapes having at least one of the features described below. In this example, the cover 150 can be made of a smooth and soft fur that covers the head and the extensions 130, 135, 155, 160 of the “Teddy” bear.

The cover 150 can be stuffed with soft cotton for soft cushion. The soft cotton can be stuffed in an interior casing (not shown) having the shape of the cover 150 such that the cover 150 can be removed from the interior casing, washed and dried in a washer and dryer, and easily put on the interior casing.

The four extensions 130, 135, 155, 160 are the arms 130, 135 and legs 155, 160, for example. The arms 130, 135 are bendable and have an attachment element 140 to attach the bendable arms 130, 135 together. The attachment elements 140 are placed at the tip of the hands of the bendable arms 130, 135. The attachment elements 140 can include hook-and-loop fasteners, a latch, a buckle, etc. The attachment elements 140 attach to each other securing the arms 130, 135 together.

Each arm 130, 135 can include an elongated bar 165 that is positioned inside and along the arm. The elongated bar 165 can be bent and has properties that maintains the bent position. For example, if the arms 130, 135 are bent 90 degrees toward each other, the arms 130, 135 can maintain the 90 degrees position without additional or outside force.

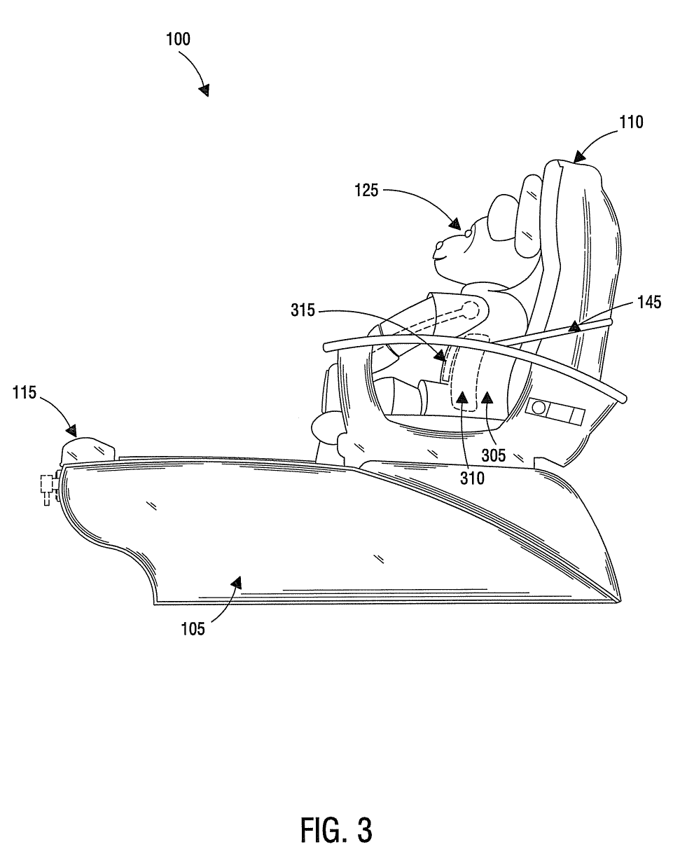

The seat adjustment device 125 further includes a strap 145 that is attached to the cover 150 at the sides of the body 305 (FIG. 3). The strap 145 wraps around the backrest of the chair 110 to secure the seat adjustment device 125 to the chair 110. The strap 145 can include a buckle (not shown) to latch the strap 145 together. Although the figures show the seat adjustment device 125 being used with a spa apparatus 100, the seat adjustment device 125 can be used with a car seat, couch, and any other similar apparatuses.

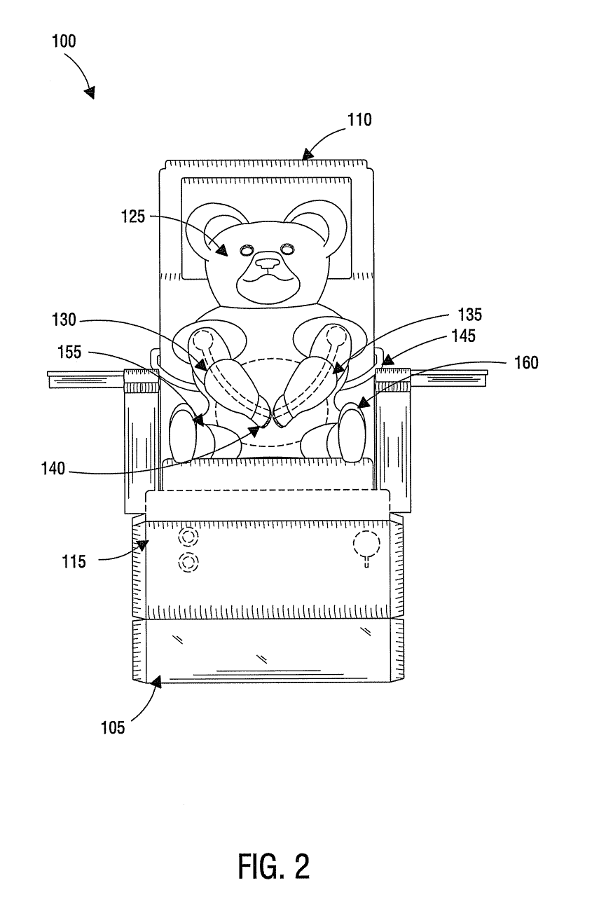

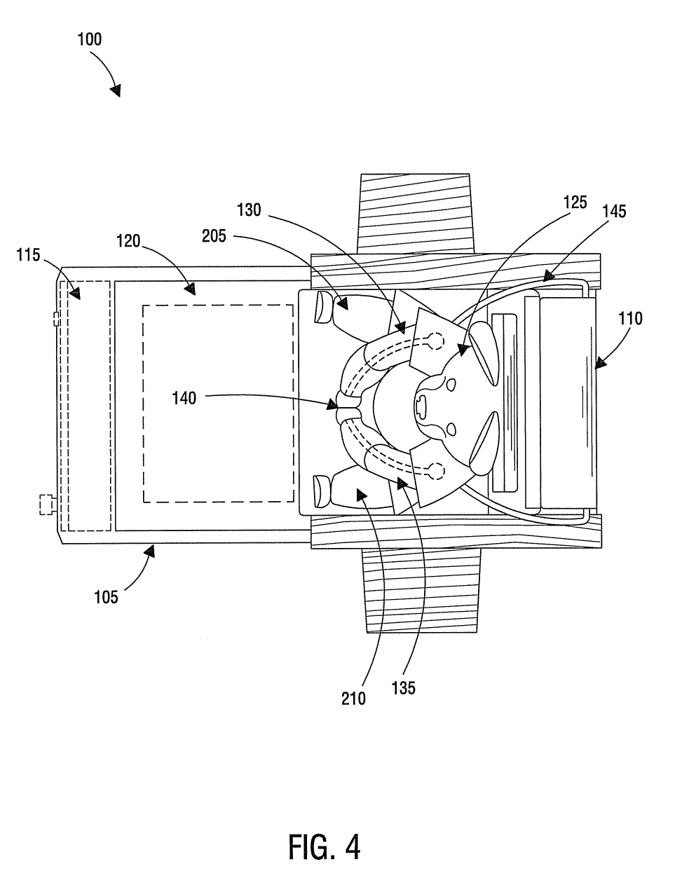

FIGS. 2, 3, and 4 are front, side, and top views, respectively, of an embodiment of a spa apparatus 100 having a seat adjustment device 125, such as that shown in FIG. 1. Referring to FIG. 2, the extensions 155, 160 are legs of the seat adjustment device 125. Each leg 155, 160 can include a hole or recess (not shown) that can be use as a cup holder.

Referring to FIG. 3, the seat adjustment device 125 can include an adjustable lumbar mechanism 310 such that a client can adjust the shape of the body 305 of the seat adjustment device 125. The adjustable lumbar mechanism 310 can adjust at least three sections of the body 305 that coincides with, for example, the lower, middle, and upper back of the client.

In addition, the adjustable lumbar mechanism 310 can adjust the depth of the seat between the backrest and the front seat. This allows the customers having heights below the “normal” (e.g., 3 feet to 4.5 feet) to be able to sit on the chair 110. The body 305 can further include a massage device 315 that is attached to the front of the body 305 and massages the back of a customer.

This description has been presented for purposes of illustration and description. It is not intended to be exhaustive or to limit the disclosure to the precise forms disclosed. Obvious modifications or variations are possible in light of the above teachings. The embodiments discussed, however, were chosen to illustrate the principles of the disclosure, and its practical application. The disclosure is thus intended to enable one of ordinary skill in the art to use the disclosure, in various embodiments and with various modifications, as are suited to the particular use contemplated. All such modifications and variation are within the scope of this disclosure, as determined by the appended claims when interpreted in accordance with the breadth to which they are fairly and legally entitled.

1. A seat adjustment device comprising:
a body;
at least two extensions that are connected to the body;
attachment elements that are placed at the tip of the at least two extensions, wherein the attachment elements attach to each other securing the at least two extensions together; and
a cover that covers the body and the at least two extensions, wherein the cover is removable and washable.

2. The seat adjustment device as defined in claim 1, wherein the at least two extensions include elongated bars that is positioned inside and along the at least two extensions, wherein the elongated bars can be bent and have properties that maintains a bent position.

3. The seat adjustment device as defined in claim 1, further comprising at least two more extensions that are attached to the body, wherein the at least two more extensions are positioned below the at least two extensions and includes cup holders.

4. The seat adjustment device as defined in claim 1, wherein the attachment elements include at least one of the following: hook-and-loop fasteners, a latch, and a buckle.

5. The seat adjustment device as defined in claim 1, further comprising a strap that is attached to the cover at the sides of the body, wherein the strap wraps around a backrest of a chair to secure the seat adjustment device to the chair.

6. The seat adjustment device as defined in claim 1, further comprising an adjustable lumbar mechanism that adjusts the shape of the body of the seat adjustment device.

7. The seat adjustment device as defined in claim 6, wherein the adjustable lumbar mechanism adjusts at least three sections of the body that coincides with the lower, middle, and upper back of a person.

8. The seat adjustment device as defined in claim 1, further, comprising massage device that is attached to the front of the body and massages a back of a person.

9. A spa apparatus comprising:
a chair;
a basin;
a base structure in which the chair and the basin are mounted thereon; and
seat adjustment device comprising:
a body,
at least two extensions that are connected to the body,
attachment elements that are placed at the tip of the at least two extensions, wherein the attachment elements attach to each other securing the at least two extensions together, and
a cover that covers the body and the at least two extensions.

10. The spa apparatus as defined in claim 9, wherein the at least two extensions include elongated bars that is positioned inside and along the at least two extensions, wherein the elongated bars can be bent and have properties that maintains a bent position.

11. The spa apparatus as defined in claim 9, further comprising at least two more extensions that are attached to the body, wherein the at least two more extensions are positioned below the at least two extensions and includes cup holders.

12. The spa apparatus as defined in claim 9, wherein the attachment elements include at least one of the following: hook-and-loop fasteners, a latch, and a buckle.

13. The spa apparatus as defined in claim 9, further comprising a strap that is attached to the cover at the sides of the body, wherein the strap wraps around a backrest of the chair to secure the seat adjustment device to the chair.

14. The spa apparatus as defined in claim 9, further comprising an adjustable lumbar mechanism that adjusts the shape of the body of the seat adjustment device.

15. The spa apparatus as defined in claim 14, wherein the adjustable lumbar mechanism adjusts at least three sections of the body that coincides with the lower, middle, and upper back of a person.

16. The spa apparatus as defined in claim 9, further comprising massage device that is attached to the front of the body and massages a back of a person.

17. A seat adjustment device comprising:
a body;
at least two extensions that are connected to the body;
attachment elements that are placed at the tip of the at least two extensions, wherein the attachment elements attach to each other securing the at least two extensions together, wherein the at least two extensions include elongated bars that is positioned inside and along the at least two extensions, wherein the elongated bars can be bent and have properties that maintains a bent position;
a cover that covers the body and the at least two extensions; and
an adjustable lumbar mechanism that adjusts the shape of the body of the seat adjustment device.

18. The seat adjustment device as defined in claim 17, wherein the adjustable lumbar mechanism adjusts at least three sections of the body that coincides with the lower, middle, and upper back of a person.

19. The seat adjustment device as defined in claim 17, further comprising massage device that is attached to the front of the body and massages a back of a person.

20. The seat adjustment device as defined in claim 17, further comprising a strap that is attached to the cover at the sides of the body, wherein the strap wraps around a backrest of a chair to secure the seat adjustment device to the chair.
